(19) United States
(12) Patent Application Publication
(10) Pub. No.: US 2021/0404817 A1
(43) Pub. Date: Dec. 30, 2021

(54) CURRENT LOCATION ESTIMATION DEVICE, CURRENT LOCATION ESTIMATION METHOD, AND PROGRAM

(71) Applicant: NIPPON TELEGRAPH AND TELEPHONE CORPORATION, Tokyo (JP)

(72) Inventors: Chihiro YAMAMOTO, Tokyo (JP); Hiroshi KONISHI, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/295,419

(22) PCT Filed: Nov. 7, 2019
(86) PCT No.: PCT/JP2019/043669

§ 371 Date: May 19, 2021

(30) Foreign Application Priority Data
Nov. 21, 2018 (JP) 2018-218190

(51) Int. Cl. G01C 21/34; G01C 21/20; G08B 7/06

(52) U.S. Cl. CPC G01C 21/3407; G01C 21/3446; G08B 7/066; G01C 21/206; G01C 21/3461

(57) ABSTRACT

A current position of a user can be estimated with high accuracy. A movability calculation unit 210 calculates, for each of a plurality of candidate routes, movability indicating the degree to which movement along the candidate route is possible, based on a movement cost that is calculated, the movement cost indicating the degree of difficulty in traveling along the candidate route by a movement means, an expected route movement time that is calculated, the expected route movement time being a time necessary to travel along the candidate route by the movement means, and a time taken to travel from a past position to a current position, and a current position estimation unit 220 estimates a candidate current position on the candidate route with the highest movability to be the current position of a user on a geographic network.

### TECHNICAL FIELD

The present invention relates to a current position estimation device, a current position estimation method and a program, and more particularly, to a current position estimation device, a current position estimation method and a program for estimating a current position of a user in relation to map information investigation.

### BACKGROUND ART

In recent years, in promoting accessibility, efforts are being made to gather conditions for enabling traveling along routes (hereinafter “accessibility information”) so that a route search appropriate for each user is performed also for users for whom the conditions for enabling traveling along routes are different from those of able-bodied people, such users including elderly people and people in wheelchairs, for example.

For example, a map information investigation support device of Patent Literature 1 is for supporting map information investigation by allowing investigation results obtained by investigators performing investigation regarding features and routes on a map while moving to be recorded in association with a geographic network (a geographic NW; for example, FIG. 19).

With such a map information investigation support device, investigation has to be supported by showing a user who is an investigator a current position of the user.

Furthermore, position information of an investigation point has to be accurate, and this requires a current position where a user is performing investigation to be accurately presented.

Because a user moves along a route on foot and stops and performs investigation when an investigation point is found, the current position has to be presented not during movement but at a timing when an investigation target is found. Accordingly, an accurate current position at a timing of each of stops at specific intervals has to be presented instead of continuous current positions.

### CITATION LIST

### Patent Literature

Patent Literature 1: Japanese Patent Laid-Open No. 2017-102279

### SUMMARY OF THE INVENTION

### Technical Problem

However, although, as a method of acquiring a current position, there is a method of using a measured position that is obtained based on position measurement information (from GPS or the like), if the measured position itself is taken as the current position, an error may occur, as shown in FIG. 20, due to an influence of a nearby building or the like. Particularly, in an area where there are many high-rise buildings, a deviation between an actual current position and a measured position may be great, not just a few meters.

The present invention has been made in view of the circumstances described above, and an object of the present invention is to provide a current position estimation device, a current position estimation method and a program that are capable of accurately estimating a current position of a user.

### Means for Solving the Problem

A current position estimation device according to the present invention includes: an input unit for receiving input of a movement means and a measured position that is a current position of a user that is observed; a candidate current position acquisition unit for acquiring, based on the measured position, a plurality of candidate current positions that are candidates for the current position on a geographic network; a candidate route extraction unit for extracting, for each of the plurality of candidate current positions that are acquired by the candidate current position acquisition unit, a candidate route that is a route that connects the candidate current position and a past position that is a position, on the geographic network, of the user in a past, and that includes a link connecting points including the candidate current position and the past position; a cost calculation unit for calculating, for each of a plurality of candidate routes, a movement cost indicating a degree of difficulty in traveling along the candidate route by the movement means; an expected movement time calculation unit for calculating, for each of the plurality of candidate routes, an expected route movement time that is a time necessary to travel along the candidate route by the movement means; a movability calculation unit for calculating, for each of the plurality of candidate routes, movability indicating a degree to which movement along the candidate route is possible, based on the movement cost calculated by the cost calculation unit, the expected route movement time calculated by the expected movement time calculation unit, and a time taken to move from the past position to the current position; and a current position estimation unit for estimating the candidate current position on the candidate route for which the movability of the candidate route is highest, among the plurality of candidate routes, to be the current position of the user on the geographic network.

Furthermore, a current position estimation method according to the present invention includes receiving, by an input unit, input of a movement means and a measured position that is a current position of a user that is observed; acquiring, by a candidate current position acquisition unit, based on the measured position, a plurality of candidate current positions that are candidates for the current position on a geographic network; extracting, by a candidate route extraction unit, for each of the plurality of candidate current positions that are acquired by the candidate current position acquisition unit, a candidate route that is a route that connects the candidate current position and a past position that is a position, on the geographic network, of the user in a past, and that includes a link connecting points including the candidate current position and the past position; calculating, by a cost calculation unit, for each of a plurality of candidate routes, a movement cost indicating a degree of difficulty in traveling along the candidate route by the movement means; calculating, by an expected movement time calculation unit, for each of the plurality of candidate routes, an expected route movement time that is a time necessary to travel along the candidate route by the movement means; calculating, by a movability calculation unit, for each of the plurality of candidate routes, movability indicating a degree to which movement along the candidate route is possible, based on the movement cost calculated by the cost calculation unit, the expected route movement time calculated by the expected movement time calculation unit, and a time taken to move from the past position to the current position; and estimating, by a current position estimation unit, the candidate current position on the candidate route for which the movability of the candidate route is highest, among the plurality of candidate routes, to be the current position of the user on the geographic network.

With the current position estimation device and the current position estimation method according to the present invention, the input unit receives input of a movement means and a measured position that is a current position of a user that is observed, the candidate current position acquisition unit acquires, based on the measured position, a plurality of candidate current positions that are candidates for the current position on a geographic network, and the candidate route extraction unit extracts, for each of the plurality of candidate current positions that are acquired by the candidate current position acquisition unit, a candidate route that is a route that connects the candidate current position and a past position that is a position, on the geographic network, of the user in a past, and that includes a link connecting points including the candidate current position and the past position.

Then, the cost calculation unit calculates, for each of a plurality of candidate routes, a movement cost indicating a degree of difficulty in traveling along the candidate route by the movement means, the expected movement time calculation unit calculates, for each of the plurality of candidate routes, an expected route movement time that is a time necessary to travel along the candidate route by the movement means, the movability calculation unit calculates, for each of the plurality of candidate routes, movability indicating a degree to which movement along the candidate route is possible, based on the movement cost calculated by the cost calculation unit, the expected route movement time calculated by the expected movement time calculation unit, and a time taken to move from the past position to the current position, and the current position estimation unit estimates the candidate current position on the candidate route for which the movability of the candidate route is highest, among the plurality of candidate routes, to be the current position of the user on the geographic network.

In this manner, the movability indicating the degree to which movement along a candidate route is possible may be calculated for each of a plurality of candidate routes, based on the movement cost that is calculated, the movement cost indicating the degree of difficulty in traveling along the candidate route by a movement means, the expected route movement time that is calculated, the expected route movement time being a time necessary to travel along the candidate route by the movement means, and the time taken to move from the past position to the current position, and a candidate current position on the candidate route with the highest movability may be estimated to be the current position of the user on the geographic network, and the current position of the user may thus be estimated with high accuracy.

Furthermore, the current position estimation device according to the present invention further includes a link overlapping rate calculation unit for calculating, for each of the plurality of candidate routes, a link overlapping rate indicating a rate of a link included in the candidate route overlapping a movement track when the movement track is matched with the candidate current position and the past position, the movement track being determined from a record of the measured position of the user that is observed, where the movability calculation unit may calculate the movability based on the movement cost calculated by the cost calculation unit, the expected route movement time calculated by the expected movement time calculation unit, the time taken to move from the past position to the current position, and the link overlapping rate calculated by the link overlapping rate calculation unit.

A current position estimation device according to the present invention includes: an input unit for receiving input of a movement means and a measured position that is a current position of a user that is observed; a candidate current position acquisition unit for acquiring, based on the measured position, a plurality of candidate current positions that are candidates for the current position on a geographic network; a candidate route extraction unit for extracting, for each of the plurality of candidate current positions that are acquired by the candidate current position acquisition unit, a candidate route that is a route that connects the candidate current position and a past position that is a position, on the geographic network, of the user in a past, and that includes a link connecting points including the candidate current position and the past position; a cost calculation unit for calculating, for each of a plurality of candidate routes, a movement cost indicating a degree of difficulty in traveling along the candidate route by the movement means; a link overlapping rate calculation unit for calculating, for each of the plurality of candidate routes, a link overlapping rate indicating a rate of a link included in the candidate route overlapping a movement track when the movement track is matched with the candidate current position and the past position, the movement track being determined from a record of the measured position of the user that is observed; a movability calculation unit for calculating, for each of the plurality of candidate routes, movability indicating a degree to which movement along the candidate route is possible, based on the movement cost calculated by the cost calculation unit and the link overlapping rate calculated by the link overlapping rate calculation unit; and a current position estimation unit for estimating the candidate current position on the candidate route for which the movability of the candidate route is highest, among the plurality of candidate routes, to be the current position of the user on the geographic network.

Furthermore, a current position estimation method according to the present invention includes receiving, by an input unit, input of a movement means and a measured position that is a current position of a user that is observed; acquiring, by a candidate current position acquisition unit, based on the measured position, a plurality of candidate current positions that are candidates for the current position on a geographic network; extracting, by a candidate route extraction unit, for each of the plurality of candidate current positions that are acquired by the candidate current position acquisition unit, a candidate route that is a route that connects the candidate current position and a past position that is a position, on the geographic network, of the user in a past, and that includes a link connecting points including the candidate current position and the past position; calculating, by a cost calculation unit, for each of a plurality of candidate routes, a movement cost indicating a degree of difficulty in traveling along the candidate route by the movement means; calculating, by a link overlapping rate calculation unit, for each of the plurality of candidate routes, a link overlapping rate indicating a rate of a link included in the candidate route overlapping a movement track when the movement track is matched with the candidate current position and the past position, the movement track being determined from a record of the measured position of the user that is observed; calculating, by a movability calculation unit, movability indicating a degree to which movement along the candidate route is possible, based on the movement cost calculated by the cost calculation unit and the link overlapping rate calculated by the link overlapping rate calculation unit; and estimating, by a current position estimation unit, the candidate current position on the candidate route for which the movability of the candidate route is highest, among the plurality of candidate routes, to be the current position of the user on the geographic network.

With the current position estimation device and the current position estimation method according to the present invention, the input unit receives input of a movement means and a measured position that is a current position of a user that is observed, the candidate current position acquisition unit acquires, based on the measured position, a plurality of candidate current positions that are candidates for the current position on a geographic network, and the candidate route extraction unit extracts, for each of the plurality of candidate current positions that are acquired by the candidate current position acquisition unit, a candidate route that is a route that connects the candidate current position and a past position that is a positon, on the geographic network, of the user in a past, and that includes a link connecting points including the candidate current position and the past position.

Then, the cost calculation unit calculates, for each of a plurality of candidate routes, a movement cost indicating a degree of difficulty in traveling along the candidate route by the movement means, the link overlapping rate calculation unit calculates, for each of the plurality of candidate routes, a link overlapping rate indicating a rate of a link included in the candidate route overlapping a movement track when the movement track is matched with the candidate current position and the past position, the movement track being determined from a record of the measured position of the user that is observed, the movability calculation unit calculates, for each of the plurality of candidate routes, movability indicating a degree to which movement along the candidate route is possible, based on the movement cost calculated by the cost calculation unit and the link overlapping rate calculated by the link overlapping rate calculation unit, and the current position estimation unit estimates the candidate current position on the candidate route for which the movability of the candidate route is highest, among the plurality of candidate routes, to be the current position of the user on the geographic network.

In this manner, the movability indicating the decree to which movement along the candidate route is possible may be calculated for each of a plurality of candidate routes, based on the movement cost that is calculated, the movement cost indicating the degree of difficulty in traveling along the candidate route by a movement means, and the link overlapping rate that is calculated, the link overlapping rate indicating a rate of a link included in the candidate route overlapping a movement track when the movement track is matched with the candidate current position and the past position, the movement track being determined from a record of the measured position of the user that is observed, and a candidate current position on the candidate route with the highest movability may be estimated to be the current position of the user on the geographic network, and the current position of the user may thus be estimated with high accuracy.

Furthermore, the current position estimation device according to the present invention may further include a past position extraction unit for extracting, as the past position, a current position on the geographic network that has been input in the past by the user or the current position that has been previously estimated by the current position estimation unit.

Furthermore, the cost calculation unit of the current position estimation device according to the present invention may calculate the movement cost for each of a plurality of candidate routes extracted by the candidate route extraction unit, based on a cost indicating a degree of difficulty in traveling determined for the movement means on a per-link basis based on accessibility information regarding a link included in the candidate route.

A program according to the present invention is a program for causing a computer to function as each unit of the current position estimation device.

### Effects of the Invention

With the current position estimation device, the current position estimation method and the program of the present invention, a current position of a user may be accurately estimated.

### BRIEF DESCRIPTION OF DRAWINGS

FIG. 1 is a schematic diagram showing an example of a configuration of a current position estimation device according to a first embodiment of the present invention.

FIG. 2 is an illustration showing an overview of the embodiment of the present invention.

FIG. 3 is an illustration showing an example of an input screen according to the embodiment of the present invention.

FIG. 4 is a table showing an example of a movement means list according to the embodiment of the present invention.

FIG. 5 is an illustration showing an example of acquisition of a candidate current position according to the embodiment of the present invention.

FIG. 6 is an illustration showing an example of a position of a last investigation point of a user according to the embodiment of the present invention.

FIG. 7 is an illustration showing examples of a link to be excluded from search according to the embodiment of the present invention.

FIG. 8 is a table showing examples of accessibility information that is a traveling condition assigned to a link according to the embodiment of the present invention.

FIG. 9 is a table showing examples of a cost indicating a degree of difficulty in traveling regarding each movement means according to the embodiment of the present invention.

FIG. 10 is a table showing examples of costs, for a plurality of links, regarding respective movement means according to the embodiment of the present invention.

FIG. 11 is a table showing an example of a speed of each movement means necessary to travel under a specific condition according to the embodiment of the present invention.

FIG. 12 is a table showing examples of a movement cost and an expected route movement time for each candidate route that are calculated, according to the embodiment of the present invention.

FIG. 13 is a flowchart showing a current position estimation processing routine of the current position estimation device according to the first embodiment of the present invention.

FIG. 14 is a schematic diagram showing an example of a configuration of a current position estimation device according to a second embodiment of the present invention.

FIG. 15 is an illustration showing an example of map matching according to the embodiment of the present invention.

FIG. 16 is a flowchart showing a current position estimation processing routine of the current position estimation device according to the second embodiment of the present invention.

FIG. 17 is a schematic diagram showing an example of a configuration of a current position estimation device according to a third embodiment of the present invention.

FIG. 18 is a flowchart showing a current position estimation processing routine of the current position estimation device according to the third embodiment of the present invention.

FIG. 19 is an illustration showing an example of a geographic NW.

FIG. 20 is an illustration showing an error between a measured position and a current position.

### DESCRIPTION OF EMBODIMENTS

Hereinafter, embodiments of the present invention will be described with reference to the drawings.

### Overview of Current Position Estimation Device According to Embodiment of Present Invention

First, an overview of an embodiment of the present invention will be given.

In relation to map information investigation support (or map display), a current position estimation device according to the present embodiment estimates a current position of a user (an investigator) based on a movement means of the user and accessibility information that is associated with position measurement information and a geographic network (NW).

A candidate route to each candidate current position of the user is extracted based on the movement means of the user and the accessibility information. Then, a movement cost, for the movement means, indicating a degree of difficulty in traveling along the candidate route and a time that is expected to be necessary to move along the candidate route (i.e., an expected movement time) are estimated for each of extracted candidate routes. Then, among estimation results, a candidate current position that can actually be reached and for which the movement cost is the smallest is estimated to be the current position of the user.

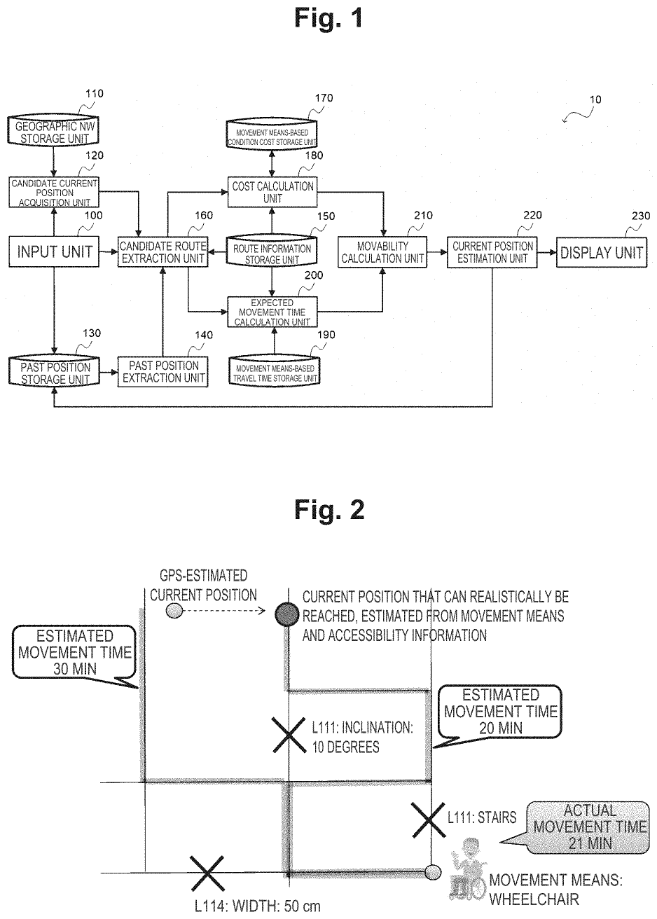

For example, as shown in FIG. 2, in a case where there is an error between a measured position based on position measurement information from a GPS or the like and a current position on the geographic NW, there are a plurality of candidates for the current position of the user. Accordingly, an expected movement time of a route to each candidate current position is estimated, and a candidate current position that can actually be reached and for which the movement cost is the smallest, among the estimation results, is estimated to be the current position. In the case where the movement means is a wheelchair, movement along a link with stairs or with a width of 50 cm is not possible, and thus, a route including a link along which movement by the movement means is not possible is excluded.

According to such a configuration, a measurement error may be compensated by information other than the position measurement information, and the position of the user may be accurately estimated.

### Configuration of Current Position Estimation Device According to First Embodiment of Present Invention

A configuration of the current position estimation device according to the embodiment of the present invention will be described with reference to FIG. 1. FIG. 1 is a block diagram showing a configuration of the current position estimation device according to the embodiment of the present invention.

A current position estimation device 10 is a computer including a CPU, a RAM, and a ROM storing a program for executing a current position estimation processing routine described later, and is configured in the following manner in terms of functions.

As shown in FIG. 1, the current position estimation device 10 according to the present embodiment includes an input unit 100, a geographic NW storage unit 110, a candidate current position acquisition unit 120, a past position storage unit 130, a past position extraction unit 140, a route information storage unit 150, a candidate route extraction unit 160, a movement means-based condition cost storage unit 170, a cost calculation unit 180, a movement means-based travel time storage unit 190, an expected movement time calculation unit 200, a movability calculation unit 210, a current position estimation unit 220, and a display unit 230.

The input unit 100 receives input of the movement means and the measured position that is a current position of a user that is observed.

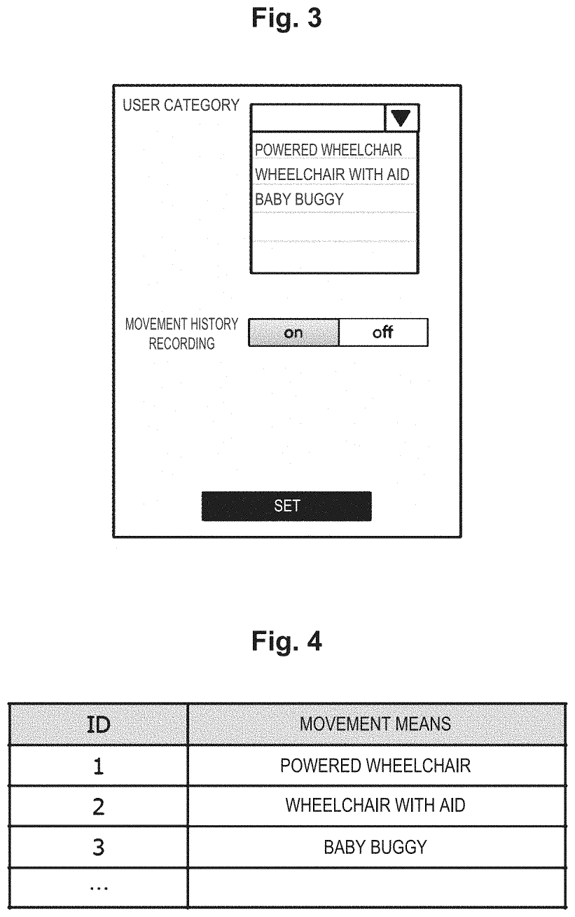

Specifically, the input unit 100 receives input of the movement means via a GUI (FIG. 3) that is displayed to a user who is supporting map information investigation and to which the movement means is to be input.

For example, the movement means may be walking of an able-bodied person, a wheelchair, a wheelchair with an aid, walking with a baby buggy, or walking with a stick. For example, the GUI in FIG. 3 displays a movement means list shown in FIG. 4, and the input unit 100 receives input of an ID corresponding to a selected movement means.

Furthermore, by performing setting regarding acquisition of position measurement information, a user may collect position measurement information during movement (a case where movement history recording in FIG. 3 is “on”).

Moreover, the input unit 100 receives input of a measured position based on position measurement information about a current position from a GPS, a beacon or the like.

Then, the input unit 100 transfers the movement means that is received to the candidate route extraction unit 160. Furthermore, the input unit 100 transfers the measured position that is received to the candidate current position acquisition unit 120.

Moreover, the input unit 100 receives input of the current position on the geographic NW from the user.

Then, the input unit 100 stores the current position of the user on the geographic NW that is received, in the past position storage unit 130. That is, the input unit 100 receives input of a position of a last investigation point (FIG. 6) of the user on the geographic NW, and stores the position in the past position storage unit 130 as a past position.

The geographic NW is stored in the geographic NW storage unit 110.

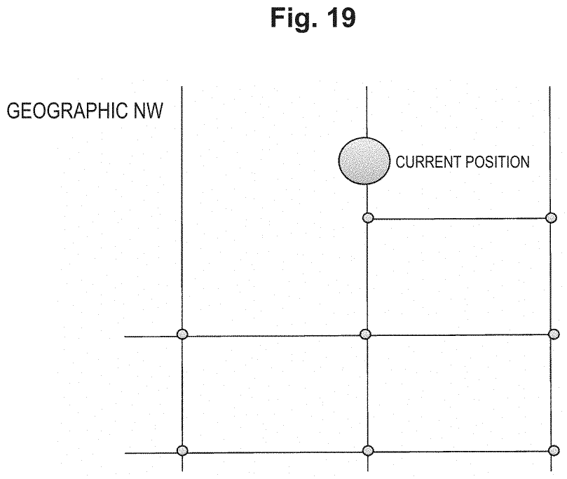

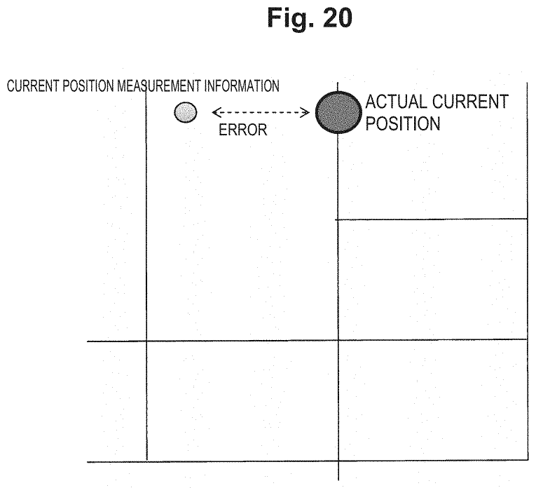

Specifically, the geographic NW includes a plurality of nodes as shown in FIG. 9 (i.e., grid points on the left in FIG. 19), and a plurality of links that are routes connecting the nodes.

The candidate current position acquisition unit 120 acquires, based on the measured position, a plurality of candidate current positions that are candidates for the current position on the geographic NW.

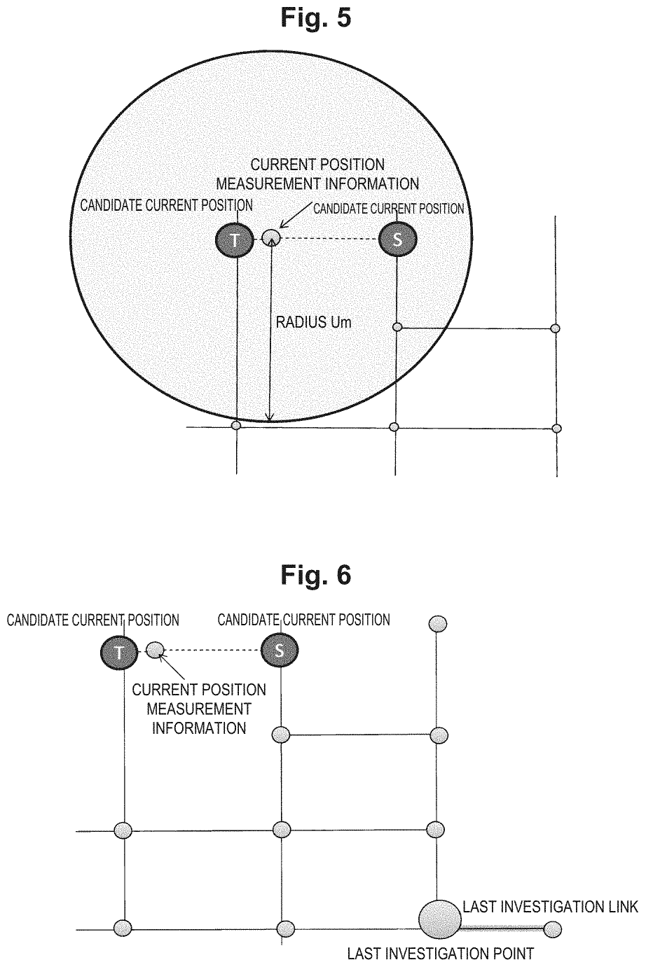

Specifically, the candidate current position acquisition unit 120 acquires, as the candidate current position, a point projected on a link, on the geographic NW, near the measured position, such as a link, on the geographic NW, included within a radius U [m] from the measured position (FIG. 5).

In the example in FIG. 5, the candidate current position acquisition unit 120 acquires, as the candidate current positions, points S and T, on the geographic NW, that are included within the radius U from the measured position.

Then, the candidate current position acquisition unit 120 transfers the plurality of candidate current positions that are acquired to the candidate route extraction unit 160.

A past position that is a position, on the geographic NW, of the user in the past is stored in the past position storage unit 130.

Specifically, a current position of the user at a time point of reception by the input unit 100 is stored as the past position in the past position storage unit 130. Furthermore, a current position that has been previously estimated by the current position estimation unit 220 is stored in the past position storage unit 130. Additionally, the past position may be a position of a node on the geographic NW or may be a position of a point on a link.

The past position extraction unit 140 extracts, as the past position, a current position, on the geographic NW, that has been input in the past by the user or a current position that has been previously estimated by the current position estimation unit 220.

Specifically, the past position extraction unit 140 extracts from the past position storage unit 130, as the past position, a position, on the geographic NW, at a time u that is most likely a position where the user was at immediately before reaching a current position at a current time t.

For example, the past position extraction unit 140 extracts the past position by one of the following methods.

### Input of Investigation Start Position by User

A position, on the geographic NW, at the time u that is a start time of investigation is set by the user himself/herself.

For example, in the case where users gather in the manner of an event to start an investigation, a place where a current position can be easily identified, such as in front of a station or in front of a specific POI, is often taken as a start position. In such a case, the user himself/herself may easily find the start position on the geographic NW, and an investigation start position may be set by the user himself/herself at the start of investigation.

In this case, the past position extraction unit 140 extracts the start position at the start of investigation as the past position, among current positions of the user that are stored in the past position storage unit 130 by the input unit 100.

### Acquisition of Last Investigation Point at Current Time

Investigation is visually performed on site, and the investigation point is input at the time, and thus, the last investigation point at the current time t may be assumed to be a last point of stay before the current time t. Accordingly, the position of the user on the geographic NW input at the time u that is a last investigation time at the current time t is acquired.

In this case, the position of the user that is acquired as an investigation point is stored in the past position storage unit 130, and the past position extraction unit 140 extracts, as the past position, the position of the user at the last investigation time that is stored in the past position storage unit 130.

### Previous Current Position Acquisition Point

A current position that has been previously estimated by the current position estimation unit 220 is stored in the past position storage unit 130, and the past position extraction unit 140 extracts, as the past position, the current position that has been previously estimated and that is stored in the past position storage unit 130.

Then, the past position extraction unit 140 transfers the past position that is extracted to the candidate route extraction unit 160.

Additionally, the past position extraction unit 140 itself may extract the past position from the input unit 100 or the current position estimation unit 220, without providing the past position storage unit 130.

Like the geographic NW storage unit 110, the route information storage unit 150 stores the geographic NW. Furthermore, accessibility information including a length, a route type and a travel condition regarding each of a plurality of links on the geographic NW is stored in association with the geographic NW in the route information storage unit 150 (FIG. 8).

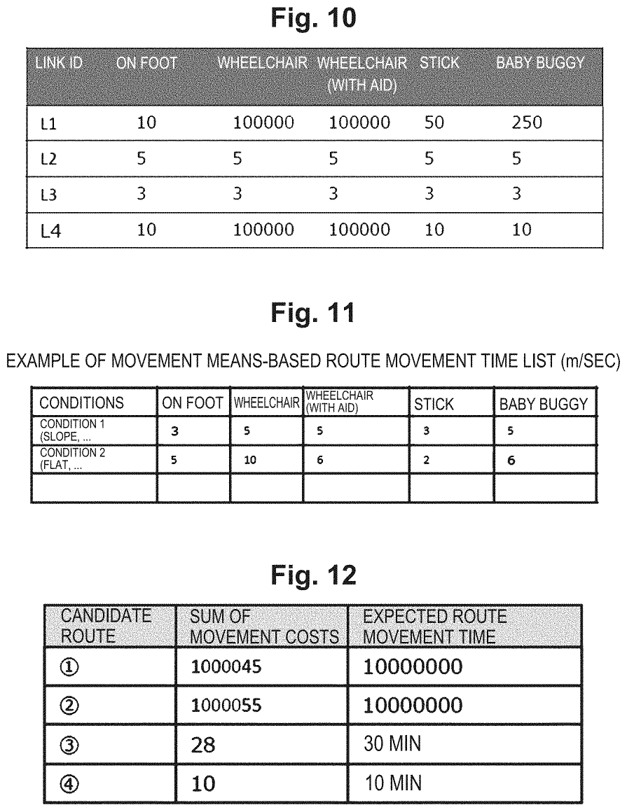

Furthermore, a cost for each movement means is stored in the route information storage unit 150, in relation to the plurality of links included in the geographic NW (FIG. 10). The cost, of a link, for each movement means may be calculated by the cost calculation unit 180 or may be manually input in advance by a person.

The candidate route extraction unit 160 extracts, for each of a plurality of candidate current positions acquired by the candidate current position acquisition unit 120, a candidate route that is a route that connects the candidate current position and a past position that is a position, on the geographic NW, of the user in the past, and that includes a link connecting points including the candidate current position and the past position.

Specifically, the candidate route extraction unit 160 first acquires the past position of the user from the past position storage unit 130, and acquires the geographic NW and the cost, for each movement means, of a link from the route information storage unit 150.

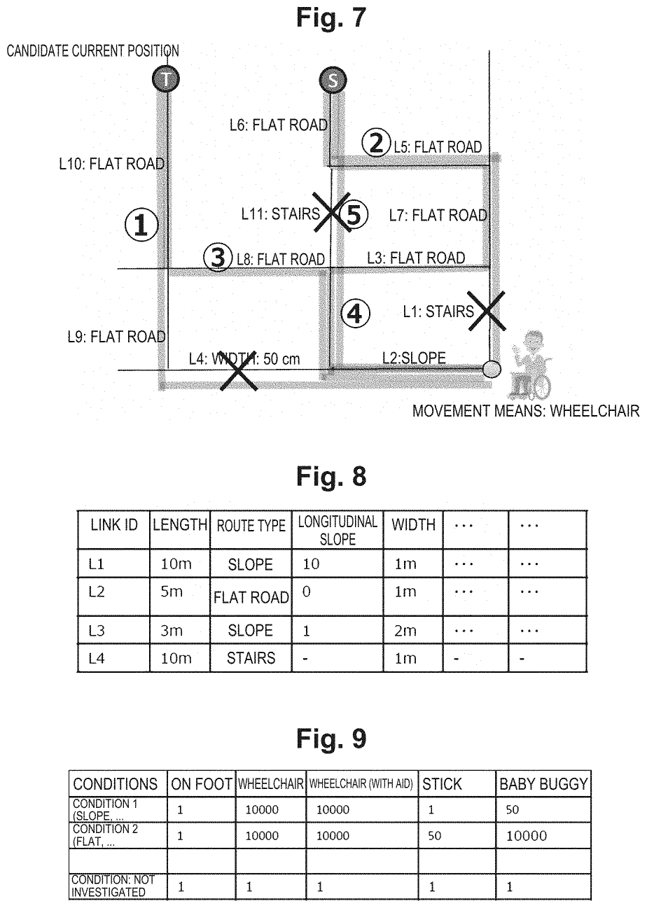

Next, the candidate route extraction unit 160 excludes, from search, a link, included in the geographic NW, the cost of which is at or greater than a threshold Z that is set in advance. For example, in the example in FIG. 7, in the case where the movement means is a wheelchair, a width of a link L4 is too narrow for the movement means, and the cost of the link is at or greater than the threshold Z. In this case, candidate routes are extracted while excluding the link L4 from the search.

The candidate route extraction unit 160 takes a past position (a node or a point on the link) as a start point and extracts, for each of a plurality of candidate current positions, a plurality of candidate routes that are candidates for the route to the candidate current position. Additionally, route search is performed using a method such as Dijkstra's algorithm, for example.

Then, the candidate route extraction unit 160 transfers the plurality of candidate routes that are extracted to the cost calculation unit 180 and the expected movement time calculation unit 200.

A condition cost indicating the degree of difficulty in traveling by a movement means under a predetermined condition is stored in the movement means-based condition cost storage unit 170, for each of a plurality of movement means (FIG. 9).

Specifically, the condition cost indicating the degree of difficulty in traveling along a link by each movement means is set in advance for each of a plurality of links included in the geographic NW.

The cost calculation unit 180 calculates, for each of the plurality of candidate routes, the movement cost indicating the degree of difficulty in traveling along the candidate route by the movement means.

Specifically, the cost calculation unit 180 first acquires the geographic NW from the route information storage unit 150 and the condition cost for the movement means from the movement means-based condition cost storage unit 170.

Next, the cost calculation unit 180 calculates, for each of the plurality of candidate routes, the movement cost for the candidate route based on the movement means. The cost calculation unit 180 calculates, for each of all the links included in the candidate route, the movement cost for the link based on the condition cost and the accessibility information of the link.

Then, the cost calculation unit 180 calculates a sum of the movement costs for all the links included in the candidate route, as the movement cost for the candidate route. FIG. 12 shows an example of a case where a sum of the movement costs for a candidate route is determined.

Additionally, in the case where the past point and the candidate current position are halfway along the link, proportional calculation is performed for the condition cost, according to distances used in the route search.

Then, the cost calculation unit 180 transfers, to the movability calculation unit 210, in relation to each of the plurality of candidate routes, the movement cost for the candidate route that is calculated. Furthermore, the cost calculation unit 180 stores the movement cost for the candidate route that is calculated, in the route information storage unit 150.

A speed (m/sec) that is necessary to travel under a specific condition is stored in the movement means-based travel time storage unit 190, for each of a plurality of movement means (a route movement time list for each movement means in FIG. 11).

The expected movement time calculation unit 200 calculates, for each of the plurality of candidate routes, an expected route movement time that is a time necessary to travel along the candidate route by the movement means.

Specifically, the expected movement time calculation unit 200 first acquires, from the movement means-based travel time storage unit 190, the speed necessary to travel by the movement means under a specific condition.

Next, the expected movement time calculation unit 200 calculates, for each of the plurality of candidate routes, the expected route movement time for each link, based on the route type, the length and the acquired speed for each link in the candidate route, and calculates a sum of the expected route movement times for the links as the expected route movement time for the candidate route (FIG. 12).

Then, the expected movement time calculation unit 200 transfers, in relation to each of the plurality of candidate routes, the expected route movement time for the candidate route to the movability calculation unit 210.

The movability calculation unit 210 calculates, for each of the plurality of candidate routes, based on the following information, movability indicating the degree to which movement along the candidate route is possible. The following information is the movement cost calculated by the cost calculation unit 180, the expected route movement time calculated by the expected movement time calculation unit 200, and a time taken to move from the past position to the current position.

Specifically, the movability calculation unit 210 calculates the movability for each of the plurality of candidate routes, based on a movement cost (c) for the candidate route, an expected route movement time (p) for the candidate route, and a time (an actual movement time) (j) taken to move from the past position to the current position.

Here, the higher the movement cost, the higher the possibility of the candidate route being a route that is difficult to move along, and thus, the candidate route will be assumed to be an unrealistic route, and a lower movement cost is therefore desirable.

Furthermore, when the difference between the actual movement time and the expected route movement time is small, closeness to the actual movement environment can be estimated.

Accordingly, the smaller the movement cost and the difference between the actual movement time and the expected route movement time, the more likely a route is assumed to be a candidate route where movement is realistically possible. Accordingly, the movability of the candidate route is calculated for each of the plurality of candidate routes using the following Formula (1).

[Formula 1] Movability=l*1/c+m*1/(j−p) (1)

Here, l and m are constants.

Then, the movability calculation unit 210 transfers the movability of the candidate route that is calculated for each of the plurality of candidate routes to the current position estimation unit 220.

The current position estimation unit 220 estimates the candidate current position on the candidate route with the highest movability, among the plurality of candidate routes, to be the current position of the user on the geographic NW.

Specifically, the current position estimation unit 220 estimates the candidate current position at an end point of the candidate route with the highest movability, among the plurality of candidate routes, to be the current position of the user.

Then, the current position estimation unit 220 stores the current position of the user that is estimated in the past position storage unit 130, and also, transfers the current position to the display unit 230.

The display unit 230 presents the current position to the user.

### Effects of Current Position Estimation Device According to First Embodiment of Present Invention

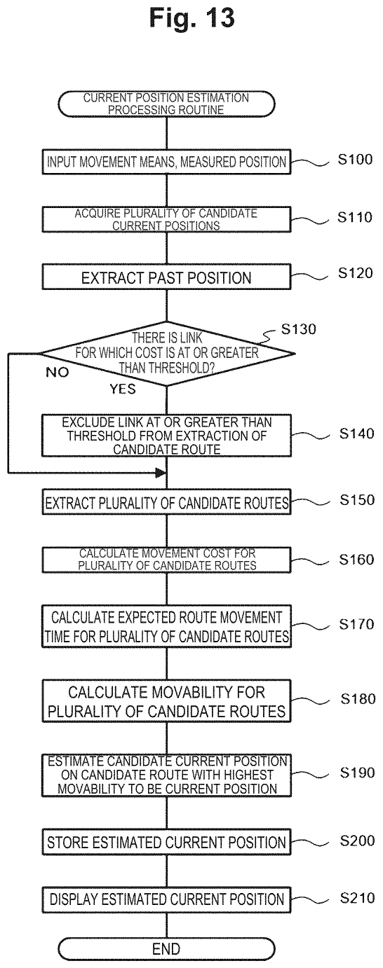

FIG. 13 is a flowchart showing a current position estimation processing routine according to the embodiment of the present invention.

When a movement means and a measured position are input to the input unit 100, the current position estimation processing routine shown in FIG. 13 is executed by the current position estimation device 10.

First, in step S100, the input unit 100 receives input of a movement means and a measured position that is a current position of the user that is observed.

In step S110, the candidate current position acquisition unit 120 acquires, based on the measured position, plurality of candidate current positions that are candidates for the current position on the geographic NW.

In step S120, the past position extraction unit 140 extracts, as a past position, a current position on the geographic NW that has been input in the past by the user or a current position that has been previously estimated by the current position estimation unit 220.

In step S130, the candidate route extraction unit 160 determines whether or not there is a link, included in the geographic NW, for which the cost is at or greater than the threshold Z that is set in advance.

In the case where there is no link that is at or greater than the threshold Z (NO in step S130 described above), step S150 is performed.

In the case where there is a link that is at or greater than the threshold Z (YES in step S130 described above), the candidate route extraction unit 160 excludes, in step S140, the link, included in the geographic NW, for which the cost is at or greater than the threshold from the search.

In step S150, the candidate route extraction unit 160 extracts a candidate route for each of the plurality of candidate current positions acquired in step S110 described above. The candidate route here is a route that connects the candidate current position and a past position that is a position, on the geographic NW, of the user in the past, and that includes a link connecting points including the candidate current position and the past position.

In step S160, the cost calculation unit 180 calculates, for each of a plurality of candidate routes, the movement cost indicating the degree of difficulty in traveling along the candidate route by the movement means.

In step S170, the expected movement time calculation unit 200 calculates, for each of the plurality of candidate routes, the expected route movement time that is the time necessary to travel along the candidate route by the movement means.

In step S180, the movability calculation unit 210 calculates, for each of the plurality of candidate routes, the movability indicating the degree to which movement along the candidate route is possible, based on the following information. The following information here is the movement cost calculated in step S160 described above, the expected route movement time calculated in step S170 described above, and the time taken to move from the past position to the current position.

In step S190, the current position estimation unit 220 estimates a candidate current position on the candidate route with the highest movability, among the plurality of candidate routes, to be the current position of the user on the geographic NW.

In step S200, the current position estimation unit 220 stores the current position of the user that is estimated in step S190 described above in the past position storage unit 130.

In step S210, the display unit 230 presents the current position to the user.

As described above, with the current position estimation device according to the embodiment of the present invention, movability indicating the degree to which movement along a candidate route is possible is calculated for each of a plurality of candidate routes based on the following three pieces of information. The first is the movement cost that is calculated, the movement cost indicating the degree of difficulty in traveling along the candidate route by a movement means. The second is the expected route movement time that is calculated, the expected route movement time being a time that is necessary to travel along the candidate route by the movement means. The third is the time that is taken to move from the past position to the current position. With the current position estimation device according to the embodiment of the present invention, a candidate current position on the candidate route with the highest movability is estimated to be the current position of the user on the geographic network. The current position of the user may thus be estimated with high accuracy.

### Configuration of Current Position Estimation Device According to Second Embodiment of Present Invention

A configuration of a current position estimation device 20 according to a second embodiment of the present invention will be described. Additionally, same structures as those of the current position estimation device 10 according to the first embodiment will be denoted by same reference signs, and a detailed description thereof will be omitted.

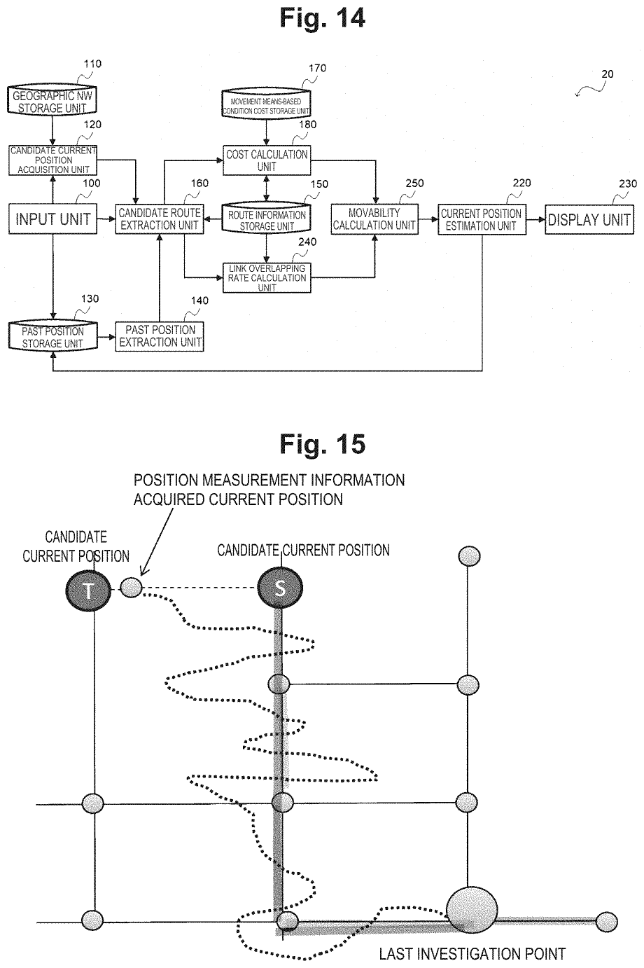

As shown in FIG. 14, the current position estimation device 20 includes the input unit 100, the geographic NW storage unit 110, the candidate current position acquisition unit 120, the past position storage unit 130, the past position extraction unit 140, the route information storage unit 150, the candidate route extraction unit 160, the movement means-based condition cost storage unit 170, the cost calculation unit 180, a link overlapping rate calculation unit 240, a movability calculation unit 250, the current position estimation unit 220, and the display unit 230.

The link overlapping rate calculation unit 240 calculates, for each of a plurality of candidate routes, a link overlapping rate indicating the rate of a link included in a candidate route overlapping a movement track when the movement track is matched with a candidate current position and a past position, the movement track being determined from a record of measured positions of the user that is observed.

Specifically, the link overlapping rate calculation unit 240 first determines a movement track of the user between a time point of a past position and a current time point, from a record of measured positions of the user that is observed, and performs matching of the movement track such that a start point and an end point of the movement track are made the past position and the candidate current position (a broken line in FIG. 15).

Matching of the movement track is performed using map matching (such as curve to curve map-matching described in Reference 1), for example.

[Reference 1] Eiji HATO, and two others, “Map-Matching Algorithm”, [online], 2014, [searched on Aug. 30, 2018], Internet <URL: http://bin.t.u-tokyo.ac.jp/startup15/file/0529yamamoto.pdf>

Next, the link overlapping rate calculation unit 240 compares, for each of a plurality of candidate routes, the candidate route and a map-matching result for the movement track, and calculates the link overlapping rate indicating the rate of the map-matching result for the movement track overlapping a link included in the candidate route.

Then, the link overlapping rate calculation unit 240 transfers, to the movability calculation unit 250, the link overlapping rate for the candidate route that is calculated for each of the plurality of candidate routes.

The movability calculation unit 250 calculates, for each of the plurality of candidate routes, the movability of the candidate route, based on the movement cost calculated by the cost calculation unit 180 and the link overlapping rate calculated by the link overlapping rate calculation unit 240.

Specifically, the movability calculation unit 210 calculates the movability for each of the plurality of candidate routes, based on a movement cost (c) for the candidate route and a link overlapping rate (q) for the candidate route.

Here, the higher the link overlapping rate for the candidate route, the higher the possibility of the candidate route actually being passed.

Accordingly, the smaller the movement cost and the higher the link overlapping rate, the more likely a route is assumed to be a candidate route where movement is realistically possible. Accordingly, the movability of the candidate route is calculated for each of the plurality of candidate routes using the following Formula (2).

[Formula 2] Movability=l*1/c+n*q (2)

Here, l and m are constants.

Then, the movability calculation unit 250 transfers the movability of each of the plurality of candidate routes that is calculated to the current position estimation unit 220.

### Effects of Current Position Estimation Device According to Second Embodiment of Present Invention

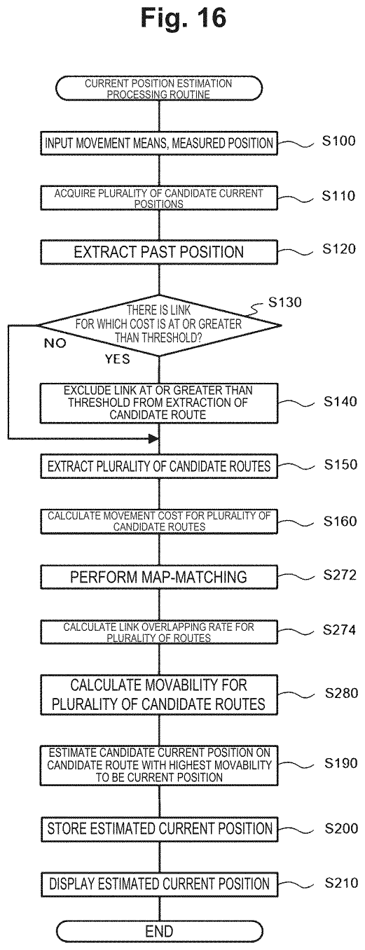

FIG. 16 is a flowchart showing a current position estimation processing routine according to the second embodiment of the present invention. Additionally, processes the same as those of the current position estimation processing routine according to the first embodiment will be denoted by same reference signs, and a detailed description thereof will be omitted.

In step S272, the link overlapping rate calculation unit 240 determines a movement track of the user between a time point of a past position and a current time point, from a record of measured positions of the user that is observed, and performs matching of the movement track such that a start point and an end point of the movement track are made the past position and the candidate current position.

In step S274, the link overlapping rate calculation unit 240 compares, for each of the plurality of candidate routes, the candidate route and a map-matching result for the movement track, and calculates the link overlapping rate indicating the rate of the map-matching result for the movement track overlapping a link included in the candidate route.

In step S280, the movability calculation unit 250 calculates, for each of the plurality of candidate routes, the movability for the candidate route, based on the movement cost calculated in step S160 described above and the link overlapping rate calculated in step S274.

As described above, with the current position estimation device according to the present embodiment, movability indicating the degree to which movement along a candidate route is possible is calculated for each of a plurality of candidate routes based on the following two pieces of information. The first is the movement cost that is calculated, the movement cost indicating the degree of difficulty in traveling along the candidate route by a movement means. The second is the link overlapping rate that is calculated, the link overlapping rate indicating the rate of a link included in a candidate route overlapping a movement track when the movement track is matched with the candidate current position and the past position, the movement track being determined from a record of measured positions of the user that is observed. With the current position estimation device according to the present embodiment, a candidate current position on the candidate route with the highest movability is estimated to be the current position of the user on the geographic network. The current position of the user may thus be estimated with high accuracy.

### Configuration of Current Position Estimation Device According to Third Embodiment of Present Invention

A configuration of a current position estimation device 30 according to a third embodiment of the present invention will be described. Additionally, same structures as those of the current position estimation device 10 according to the first embodiment and the current position estimation device 20 according to the second embodiment will be denoted by same reference signs, and a detailed description thereof will be omitted.

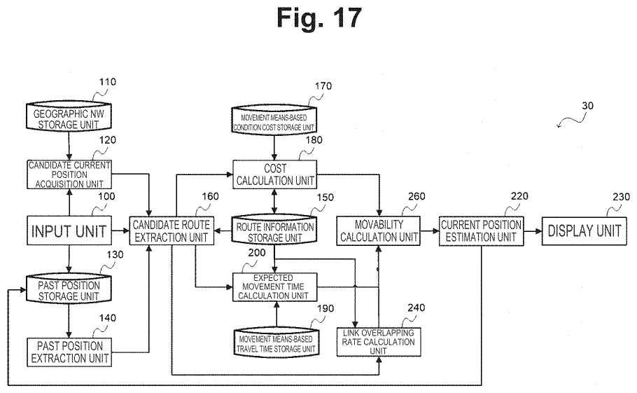

As shown in FIG. 17, the current position estimation device 30 includes the input unit 100, the geographic NW storage unit 110, the candidate current position acquisition unit 120, the past position storage unit 130, the past position extraction unit 140, the route information storage unit 150, the candidate route extraction unit 160, the movement means-based condition cost storage unit 170, the cost calculation unit 180, the movement means-based travel time storage unit 190, the expected movement time calculation unit 200, the link overlapping rate calculation unit 240, a movability calculation unit 260, the current position estimation unit 220, and the display unit 230.

The movability calculation unit 260 calculates the movability for each of a plurality of candidate routes based on the following information. The following information is the movement cost calculated by the cost calculation unit 180, the expected route movement time calculated by the expected movement time calculation unit 200, a time taken to move from the past position to the current position, and the link overlapping rate calculated by the link overlapping rate calculation unit 240.

The smaller the movement cost and the difference between the actual movement time and the expected route movement time, and the higher the link overlapping rate, the more likely a route is assumed to he a candidate route where movement is realistically possible. Accordingly, the movability of the candidate route is calculated for each of the plurality of candidate routes using the following Formula (3).

[Formula 3] Movability=l*1/c+m*1/(j−p)+N*q (3)

Here, l and m are constants.

### Effects of Current Position Estimation Device According to Third Embodiment of Present Invention

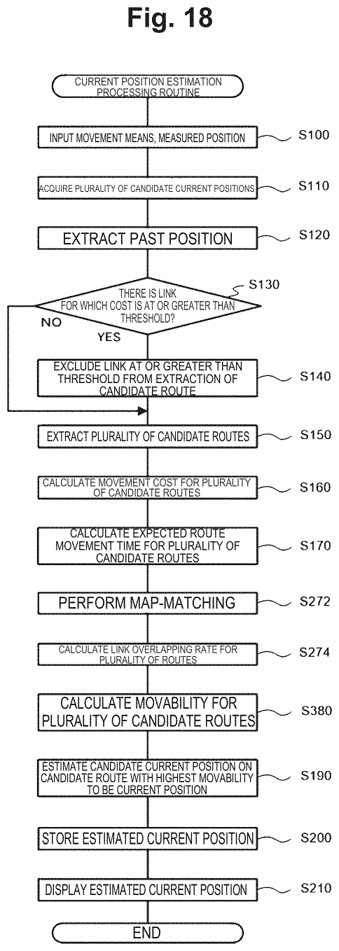

FIG. 18 is a flowchart showing a current position estimation processing routine according to the third embodiment of the present invention. Additionally, processes the same as those of the current position estimation processing routine according to the first embodiment and the current position estimation processing routine according to the second embodiment will be denoted by same reference signs, and a detailed description thereof will be omitted.

In step S380, the movability calculation unit 260 calculates the movability for each of the plurality of candidate routes based on the following information. The following information is the movement cost calculated by the cost calculation unit 180, the expected route movement time calculated by the expected movement time calculation unit 200, a time taken to move from the past position to the current position, and the link overlapping rate calculated by the link overlapping rate calculation unit 240.

As described above, with the current position estimation device according to the present embodiment, movability indicating the degree to which movement along a candidate route is possible is calculated for each of a plurality of candidate routes based on the following four pieces of information. The first is the movement cost that is calculated, the movement cost indicating the degree of difficulty in traveling along the candidate route by a movement means. The second is the expected route movement time that is calculated, the expected route movement time being a time that is necessary to travel along the candidate route by the movement means. The third is the time that is taken to move from the past position to the current position. The fourth is the link overlapping rate that is calculated, the link overlapping rate indicating the rate of a link included in a candidate route overlapping a movement track when the movement track is matched with a candidate current position and the past position, the movement track being determined from a record of measured positions of a user that is observed. With the current position estimation device according to the present embodiment, a candidate current position on the candidate route with the highest movability is estimated to be the current position of the user on the geographic network. The current position of the user may thus be estimated with high accuracy.

Additionally, the present invention is not limited to the embodiments described above, and various modifications and applications are possible within the scope of the invention.

Furthermore, in the specification of the present application, embodiments are described assuming that programs are already installed, but the programs may alternatively be provided. being stored in a computer-readable recording medium.

### REFERENCE SIGNS LIST

10 current position estimation device

20 current position estimation device

30 current position estimation device

100 input unit

110 storage unit

120 candidate current position acquisition unit

130 past position storage unit

140 past position extraction unit

150 route information storage unit

160 candidate route extraction unit

170 movement means-based condition cost storage unit

180 cost calculation unit

190 movement means-based travel time storage unit

200 expected movement time calculation unit

210 movability calculation unit

220 current position estimation unit

230 display unit

240 link overlapping rate calculation unit

250 movability calculation unit

260 movability calculation unit

1. A current position estimation device comprising:
a receiver configured to receive input of a movement means and a measured position that is a current position of a user that is observed;
a candidate current position acquirer configured to acquire, based on the measured position, a plurality of candidate current positions that are candidates for the current position on a geographic network;
a candidate route extractor configured to extract, for each of the plurality of candidate current positions that are acquired by the candidate current position acquirer, a candidate route that is a route that connects the candidate current position and a past position that is a position, on the geographic network, of the user in a past, and that includes a link connecting points including the candidate current position and the past position;
a cost determiner configured to determine, for each of a plurality of candidate routes, a movement cost indicating a degree of difficulty in traveling along the candidate route by the movement means;
an expected movement time determiner configured to determine, for each of the plurality of candidate routes, an expected route movement time that is a time necessary to travel along the candidate route by the movement means;
a movability determiner configured to determine, for each of the plurality of candidate routes, movability indicating a degree to which movement along the candidate route is possible, based on the movement cost determined by the cost determiner, the expected route movement time determined by the expected movement time determiner, and a time taken to move from the past position to the current position; and
a current position estimator configured to estimate the candidate current position on the candidate route for which the movability of the candidate route is highest, among the plurality of candidate routes, to be the current position of the user on the geographic network.

2. The current position estimation device according to claim 1, further comprising a link overlapping rate determiner configured to determine, for each of the plurality of candidate routes, a link overlapping rate indicating a rate of a link included in the candidate route overlapping a movement track when the movement track is matched with the candidate current position and the past position, the movement track being determined from a record of the measured position of the user that is observed, wherein
the movability determiner determines the movability based on the movement cost determined by the cost determiner, the expected route movement time determined by the expected movement time determiner, the time taken to move from the past position to the current position, and the link overlapping rate determined by the link overlapping rate determiner.

3. The current position estimation device according to claim 1, the device comprising:
a link overlapping rate determiner configured to determine, for each of the plurality of candidate routes, a link overlapping rate indicating a rate of a link included in the candidate route overlapping a movement track when the movement track is matched with the candidate current position and the past position, the movement track being determined from a record of the measured position of the user that is observed; and
the movability determiner configured to determine, for each of the plurality of candidate routes, the movability indicating the degree to which movement along the candidate route is possible, based on the movement cost determined by the cost determiner and the link overlapping rate determined by the link overlapping rate determiner.

4. The current position estimation device according to claim 1, further comprising a past position extractor configured to extract, as the past position, a current position on the geographic network that has been input in the past by the user or the current position that has been previously estimated by the current position estimator.

5. The current position estimation device according to claim 1, wherein the cost determiner determines the movement cost for each of a plurality of candidate routes extracted by the candidate route extractor, based on a cost indicating a degree of difficulty in traveling determined for the movement means on a per-link basis based on accessibility information regarding a link included in the candidate route.

6. A current position estimation method comprising:
receiving, by a receiver, input of a movement means and a measured position that is a current position of a user that is observed;
acquiring, by a candidate current position acquirer, based on the measured position, a plurality of candidate current positions that are candidates for the current position on a geographic network;
extracting, by a candidate route extractor, for each of the plurality of candidate current positions that are acquired by the candidate current position acquirer, a candidate route that is a route that connects the candidate current position and a past position that is a position, on the geographic network, of the user in a past, and that includes a link connecting points including the candidate current position and the past position;
determining, by a cost determiner, for each of a plurality of candidate routes, a movement cost indicating a degree of difficulty in traveling along the candidate route by the movement means;
determining, by an expected movement time determiner, for each of the plurality of candidate routes, an expected route movement time that is a time necessary to travel along the candidate route by the movement means;
determining, by a movability determiner, for each of the plurality of candidate routes, movability indicating a degree to which movement along the candidate route is possible, based on the movement cost calculated by the cost determiner, the expected route movement time determined by the expected movement time determiner, and a time taken to move from the past position to the current position; and
estimating, by a current position estimator, the candidate current position on the candidate route for which the movability of the candidate route is highest, among the plurality of candidate routes, to be the current position of the user on the geographic network.

7. The current position estimation method according to claim 6, the method comprising:
determining, by a link overlapping rate determiner, for each of the plurality of candidate routes, a link overlapping rate indicating a rate of a link included in the candidate route overlapping a movement track when the movement track is matched with the candidate current position and the past position, the movement track being determined from a record of the measured position of the user that is observed;
determining, by the movability determiner, movability indicating the degree to which movement along the candidate route is possible, based on the movement cost determined by the cost determiner and the link overlapping rate determined by the link overlapping rate determiner.

8. A computer-readable non-transitory recording medium storing computer-executable program instructions that when executed by a processor cause a computer system to:
receive, by a receiver, input of a movement means and a measured position that is a current position of a user that is observed;
acquire, by a candidate current position acquirer, based on the measured position, a plurality of candidate current positions that are candidates for the current position on a geographic network;
extract, by a candidate route extractor, for each of the plurality of candidate current positions that are acquired by the candidate current position acquirer, a candidate route that is a route that connects the candidate current position and a past position that is a position, on the geographic network, of the user in a past, and that includes a link connecting points including the candidate current position and the past position;
determine, by a cost determiner, for each of a plurality of candidate routes, a movement cost indicating a degree of difficulty in traveling along the candidate route by the movement means;
determine, by an expected movement time determiner, for each of the plurality of candidate routes, an expected route movement time that is a time necessary to travel along the candidate route by the movement means;
determine, by a movability determiner, for each of the plurality of candidate routes, movability indicating a degree to which movement along the candidate route is possible, based on the movement cost calculated by the cost determiner, the expected route movement time determined by the expected movement time determiner, and a time taken to move from the past position to the current position; and
estimate, by a current position estimator, the candidate current position on the candidate route for which the movability of the candidate route is highest, among the plurality of candidate routes, to be the current position of the user on the geographic network.

9. The current position estimation device according to claim 2, further comprising a past position extractor configured to extract, as the past position, a current position on the geographic network that has been input in the past by the user or the current position that has been previously estimated by the current position estimator.

10. The current position estimation device according to claim 2, wherein the cost determiner determines the movement cost for each of a plurality of candidate routes extracted by the candidate route extractor, based on a cost indicating a degree of difficulty in traveling determined for the movement means on a per-link basis based on accessibility information regarding a link included in the candidate route.

11. The current position estimation method according to claim 6, the method further comprising:
determining, by a link overlapping rate determiner, for each of the plurality of candidate routes, a link overlapping rate indicating a rate of a link included in the candidate route overlapping a movement track when the movement track is matched with the candidate current position and the past position, the movement track being determined from a record of the measured position of the user that is observed, wherein
the movability determiner determines the movability based on the movement cost determined by the cost determiner, the expected route movement time determined by the expected movement time determiner, the time taken to move from the past position to the current position, and the link overlapping rate determined by the link overlapping rate determiner.

12. The current position estimation method according to claim 6, the method further comprising:
extracting, by a past position extractor, as the past position, a current position on the geographic network that has been input in the past by the user or the current position that has been previously estimated by the current position estimator.

13. The current position estimation method according to claim 6, wherein the cost determiner determines the movement cost for each of a plurality of candidate routes extracted by the candidate route extractor, based on a cost indicating a degree of difficulty in traveling determined for the movement means on a per-link basis based on accessibility information regarding a link included in the candidate route.

14. The current position estimation method according to claim 11, the method further comprising:
extracting, by a past position extractor, as the past position, a current position on the geographic network that has been input in the past by the user or the current position that has been previously estimated by the current position estimator.

15. The current position estimation method according to claim 11, wherein the cost determiner determines the movement cost for each of a plurality of candidate routes extracted by the candidate route extractor, based on a cost indicating a degree of difficulty in traveling determined for the movement means on a per-link basis based on accessibility information regarding a link included in the candidate route.

16. The computer-readable non-transitory recording medium according to claim 8, the computer-executable program instructions when executed further causing the computer system to:
determine, by a link overlapping rate determiner, for each of the plurality of candidate routes, a link overlapping rate indicating a rate of a link included in the candidate route overlapping a movement track when the movement track is matched with the candidate current position and the past position, the movement track being determined from a record of the measured position of the user that is observed, wherein
the movability determiner determines the movability based on the movement cost determined by the cost determiner, the expected route movement time determined by the expected movement time determiner, the time taken to move from the past position to the current position, and the link overlapping rate determined by the link overlapping rate determiner.

17. The computer-readable non-transitory recording medium according to claim 8, the computer-executable program instructions when executed further causing the computer system to:
determine, by a link overlapping rate determiner, for each of the plurality of candidate routes, a link overlapping rate indicating a rate of a link included in the candidate route overlapping a movement track when the movement track is matched with the candidate current position and the past position, the movement track being determined from a record of the measured position of the user that is observed;
determine, by the movability determiner, movability indicating the degree to which movement along the candidate route is possible, based on the movement cost determined by the cost determiner and the link overlapping rate determined by the link overlapping rate determiner.

18. The computer-readable non-transitory recording medium according to claim 8, the computer-executable program instructions when executed further causing the computer system to:
extract, by a past position extractor, as the past position, a current position on the geographic network that has been input in the past by the user or the current position that has been previously estimated by the current position estimator.

19. The computer-readable non-transitory recording medium according to claim 8, wherein the cost determiner determines the movement cost for each of a plurality of candidate routes extracted by the candidate route extractor, based on a cost indicating a degree of difficulty in traveling determined for the movement means on a per-link basis based on accessibility information regarding a link included in the candidate route.

20. The computer-readable non-transitory recording medium according to claim 16, the computer-executable program instructions when executed further causing the computer system to:
extract, by a past position extractor, as the past position, a current position on the geographic network that has been input in the past by the user or the current position that has been previously estimated by the current position estimator.
